(19) United States
(12) Patent Application Publication
(10) Pub. No.: US 2015/0011238 A1
(43) Pub. Date: Jan. 8, 2015

(54) Unilateral Geolocation for Mobile Terminals

(71) Applicant: Broadcom Corporation, Irvine, CA (US)

(72) Inventor: Djordje TUJKOVIC, Mountain View, CA (US)

(73) Assignee: Broadcom Corporation, Irvine, CA (US)

(21) Appl. No.: 14/323,513

(22) Filed: Jul. 3, 2014

Related U.S. Application Data
(60) Provisional application No. 61/843,233, filed on Jul. 5, 2013.

(51) Int. Cl. H04W 4/02

(52) U.S. Cl. CPC H04W 4/02
USPC 455/456.1

(57) ABSTRACT

Systems and methods for enabling accurate unilateral geolocation in a user equipment (UE) are provided. In one embodiment, the UE utilizes network attachments steps to determine an estimate of a propagation time difference between two base stations. The UE then estimates a transmit time difference between the two base stations using the estimate of the propagation time difference and Observed Time Difference of Arrival (OTDOA) assistance data received from the network. The UE computes its position based on the transmit time difference and OTDOA measurements. In another embodiment, the UE uses measurements from multiple receive antenna elements to measure an Angle Difference of Arrival (ADO) between multiple base stations and a reference base station, and computes its position based on the ADOA measurements.

### CROSS-REFERENCE TO RELATED APPLICATION(S)

The present application claims the benefit of U.S. Provisional Application No. 61/843,233, filed Jul. 5, 2013, which is incorporated herein by reference in its entirety.

### TECHNICAL FIELD

The present disclosure relates generally to unilateral geolocation for mobile terminals.

### BACKGROUND

1. Background

The Third Generation Partnership Project (3GPP) Long Term Evolution (LTE) standard introduced Positioning Reference Signals (PRS) in Release-9 of the standard specification to enable User Equipment (UE)-assisted geolocation of users by a cellular network. The PRS include densely scheduled pilots in the time and frequency domains, typically spanning the entire LTE system bandwidth, that are transmitted periodically from multiple base stations.

### BRIEF DESCRIPTION OF THE DRAWINGS/FIGURES

The accompanying drawings, which are incorporated herein and form a part of the specification, illustrate the present disclosure and, together with the description, further serve to explain the principles of the disclosure and to enable a person skilled in the pertinent art to make and use the disclosure.

FIG. 1 illustrates an example environment in which embodiments can be implemented or practiced.

FIG. 2 illustrates an example user equipment (UE) according to an embodiment.

FIG. 3 illustrates an example process according to an embodiment.

FIG. 4 illustrates another example UE according to an embodiment.

FIG. 5 illustrates another example process according to an embodiment.

The present disclosure will be described with reference to the accompanying drawings. Generally, the drawing in which an element first appears is typically indicated by the leftmost digit(s) in the corresponding reference number.

### DETAILED DESCRIPTION OF EMBODIMENTS

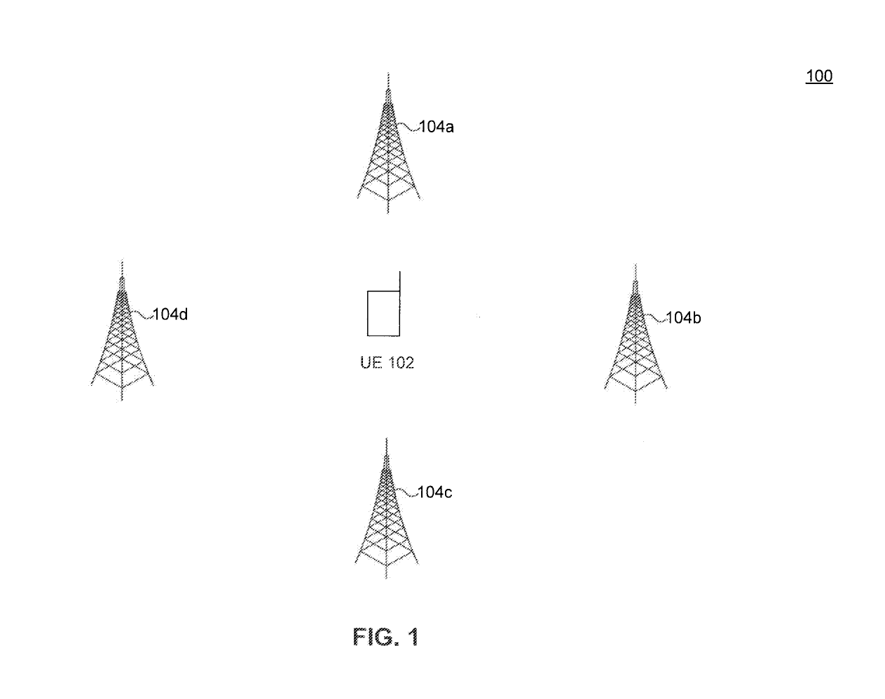

FIG. 1 illustrates an example environment 100 in which embodiments can be practiced or implemented. Example environment 100 is provided for the purpose of illustration only and is not limiting of embodiments. As shown in FIG. 1, example environment 100 includes, without limitation, a User Equipment (UE) 102 and a plurality of base stations 104a, 104b, 104c, and 104d.

Base stations 104a-d can be cellular network base stations, such as LTE eNBs, WCDMA Node Bs, or WiMAX base stations, for example. Alternatively, base stations 104a-d can be wireless network access points (APs), such as WLAN or Bluetooth APs, for example. UE 102 can be a cellular mobile terminal or a WLAN or Bluetooth device, for example.

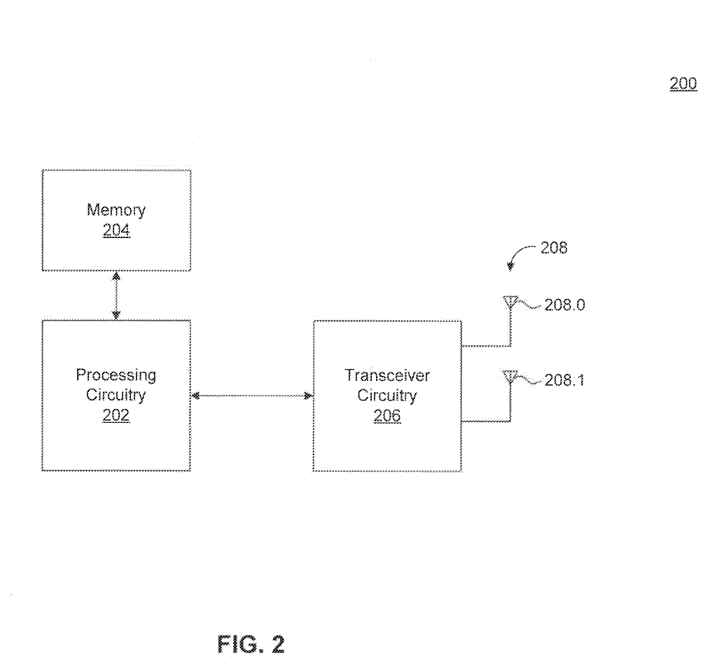

In an embodiment, UE 102 can be implemented as illustrated by example communication device 200 shown in FIG. 2. Example communication device 200 is provided for the purpose of illustration only and is not limiting of embodiments. As shown in FIG. 2, example communication device 200 includes, without limitation, a processor circuitry 202, a memory 204, a transceiver circuitry 206, and an antenna array 208 including a plurality of antenna elements 208.0 and 208.1. It is noted that in other embodiments, antenna array 208 can include more or less than two antenna elements.

Processor circuitry 202 can be implemented as described herein and can be configured to perform the UE functionalities described herein. In an embodiment, processor circuitry 202 executes logic instructions stored in memory 204 to perform the functionalities described herein. Transceiver circuitry 206 includes digital and/or analog circuitry that perform transmit and receive radio frequency (RF) processing, including filtering, power amplification, frequency up-conversion, frequency down-conversion, etc. Together with antenna array 208, transceiver circuitry 206 enables transmitting and receiving signals by communication device 200. In an embodiment, transceiver circuitry 206 and/or antenna array 208 can be controlled by processor circuitry 202 to transmit/receive at specified time-frequency resources (physical resource elements).

Returning to FIG. 1, UE 102 can be within communication range of one or more base stations 104a-d. For example, in an embodiment, UE 102 may be served by base station 104a (which is then referred to as a primary or a serving base station for UE 102) and may also receive signals transmitted by one or more of base stations 104b-d. UE 102 may attach to one or more of base stations 104b-d as secondary base stations but does not need to do so in order to receive signals transmitted by base stations 104b-d.

In Release 9, the Third Generation Partnership Project (3GPP) Long Term Evolution (LTE) standard introduced UE-assisted geolocation of mobile terminals by a cellular network. Under this scheme, Positioning Reference Signals (PRS), which include densely scheduled pilots in the time and frequency domains, are transmitted periodically by multiple base stations. For example, with reference to FIG. 1, the PRS can be transmitted by one or more of base stations 104a-d.

A UE, such as UE 102, can receive PRS from multiple base stations. For one or more of the multiple base stations, the UE computes an Observed Time Difference of Arrival (OTDOA) relative to a predefined reference base station. The predefined reference base station can be the serving base station of the UE. In an embodiment, the UE is configured by the network to perform OTDOA measurement for a specified set of base stations. In another embodiment, the UE can identify the set of base stations without network instruction. The UE sends an OTDOA report including computed OTDOAs to the network.

In FIG. 1, UE 102 may determine an OTDOA for one or more of base stations 104b-d relative to base station 104a. The OTDOA for base station 104b, for example, may be a difference between a receive time of PRS transmitted from base station 104b and a receive time of PRS transmitted from base station 104a (the reference base station). For example, the OTDOA can be computed as the difference between the receive time of the first PRS (first in time in a downlink subframe) transmitted from base station 104b and the received time of the first PRS from base station 104a. It is noted that the PRS may or may not occupy the same time-frequency resource elements in a downlink subframe for all base stations. However, typically, the UE is aware of any PRS time offsets between base stations and accounts for such PRS time offsets in the computation of the OTDOAs. For example, if the first PRS of base station 104a occurs n symbols before the first PRS of base station 104b within the downlink subframe, then the OTDOA between base stations 104a and 104b is computed as the difference between the first PRS receive times minus the duration of n symbols.

In Frequency Division Duplexing (FDD) mode LTE, base stations are not required to be time synchronized. This means that downlink subframes transmitted by any two base stations in the network may be offset in time relative to each other (i.e., a transmit time difference can exist between downlink subframes of the two base stations). To mitigate against this lack of time synchronization, the network ensures that periodic PRS occasions (which can include up to 6 consecutive 1 millisecond subframes carrying PRS) are roughly synchronized across the various base stations. In addition, the LTE Positioning Protocol (LPP) provisions for OTDOA assistance data to be sent from a positioning server to UEs to assist the UEs in locating the PRS.

The OTDOA assistance data includes an expected Received Signal Time Difference (expectedRSTD) and an expected RSTD uncertainty (expectedRSTD-Uncertainty) for each base station in the OTDOA report transmitted by the UE. Like the OTDOA, the expected RSTD for a base station is relative to the reference base station, and provides an expected measurement value for the OTDOA. The expected RSTD uncertainty is an uncertainty associated with the expected RSTD due to inaccuracy in the position server's estimate of the current position of the UE. Together, the expected RSTD and the expected RSTD uncertainty for a particular base station help the UE focus its search for the PRS transmitted by the base station (the PRS is scrambled by a scrambling code associated with the base station, and the UE typically performs a correlation search to locate the PRS), by narrowing the search window to a smaller range around the expected RSTD and based on the expected RSTD uncertainty.

However, the expected RSTD is not designed to account for the transmit time difference between two base stations. In other words, the expected RSTD value reflects both an expected propagation time difference as well as the transmit time difference between the two base stations. As such, the UE is unable to infer propagation time differences from the OTDOA assistance data, and thus cannot accurately compute its own position even with knowledge of base station positions. Furthermore, the expected RSTD and the expected RSTD uncertainty are defined with a resolution of 97 nanoseconds (they can each have values that are multiples of 97 nanoseconds), which renders the accuracy of unilateral geolocation based on OTDOA inadequate (e.g., with the speed of light at 1 foot/nanosecond, the maximum achievable accuracy is in multiples of 100 feet or ˜30 m).

Embodiments, as further described below, include systems and methods for enabling accurate unilateral geolocation in a UE. In one embodiment, the UE utilizes network attachments steps to determine an estimate of a propagation time difference between two base stations. The UE then estimates a transmit time difference between the two base stations using the estimate of the propagation time difference and OTDOA assistance data received from the network. The UE computes its position based on the transmit time difference and OTDOA measurements. In another embodiment, the UE uses measurements from multiple receive antenna elements of reference signals to measure an Angle Difference of Arrival (ADOA) between multiple base stations and a reference base station, and computes its position based on the ADOA measurements. The two methods can be used alone or in combination to achieve accurate unilateral geolocation in the UE.

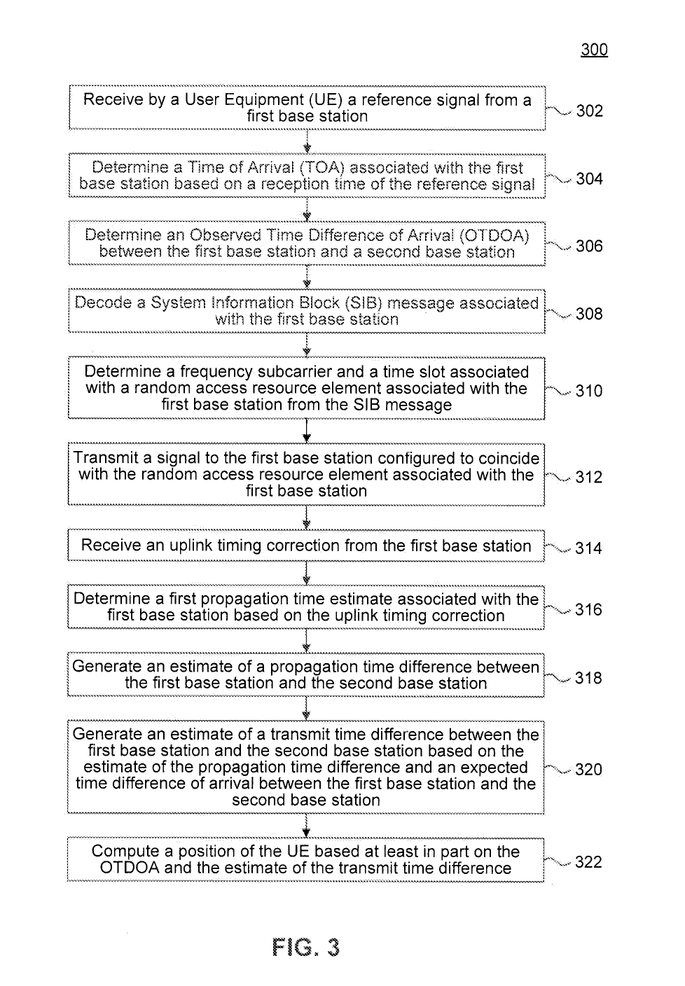

FIG. 3 illustrates an example process 300 according to an embodiment. Example process 300 is provided for the purpose of illustration only and is not limiting of embodiments. Example process 300 can be performed by a UE, such as UE 102, and more specifically by processor circuitry such as processor circuitry 202 of example communication device 200. For the purpose of illustration only, example process 300 is described with reference to UE 102 in example environment 100.

As shown in FIG. 3, example process 300 begins in step 302, which includes receiving a reference signal from a first base station. In an embodiment, the first base station is a non-serving base station of the UE. For example, the first base station may be base station 104b in example environment 100. In an embodiment, the reference signal includes a Positioning Reference Signal (PRS).

Step 304 includes determining a time of arrival (TOA) associated with the first base station based on a receive time of the reference signal. In an embodiment, the TOA associated with the first base station corresponds to a receive start time of a downlink subframe transmitted by the first base station. Alternatively, the TOA associated with the first base station may be the receive start time of the reference signal.

Subsequently, step 306 includes determining an Observed Time Difference of Arrival (OTDOA) between the first base station and a second base station. The second base station is a reference base station, which may be the serving base station of the UE. For example, the second base station may be serving base station 104a in example environment 100. In an embodiment, step 306 includes subtracting the TOA associated with the first base station from a TOA associated with the second base station to determine the OTDOA. The TOA associated with the second base station may be determined also based on receiving a reference signal from the second base station as in steps 302 and 304. In another embodiment, where the second base station is the serving base station of the UE, the TOA can be readily available to the UE because the UE is synchronized with the serving base station and accurately knows the receive start time of the downlink subframe or the receive start time of the reference signal from the serving base station.

As described above, the OTDOA between the first base station and the second base station corresponds to a sum of the propagation time difference and the transmit time difference between the first base station and the second base station. The transmit time difference between the first base station and the second base station corresponds to a difference between transmission start times of a first downlink subframe transmitted by the first base station and a second downlink subframe transmitted by the second base station (i.e., synchronization offset).

Next, process 300 proceeds to step 308, which includes decoding a System Information Block (SIB) message associated with the first base station. Then, step 310 includes determining a frequency subcarrier and a time slot associated with a random access resource element associated with the first base station from the SIB message. In an embodiment, the random access resource element is a Physical Random Access Channel (PRACH) resource element. In an embodiment, the SIB message includes information regarding Physical Random Access Channel (PRACH) opportunities advertised by the first base station, which can be used by UEs wishing to attach to the first base station. In another embodiment, rather than decoding the SIB message in step 308, PRACH opportunities of the first base station are provided to the UE by its serving base station.

Subsequently, in step 312, process 300 includes transmitting a signal to the first base station configured to coincide with the random access resource element associated with the first base station. In an embodiment, step 312 includes the UE aligning its start transmit time of the signal based on the TOA associated with the first base station determined in step 304. For example, if the random access resource element was located at a time offset T from the beginning of the uplink subframe of the first base station, then the UE would begin its transmission at a time TOA+T. In an embodiment, the signal is a PRACH signal that includes a PRACH preamble belonging to the set defined for initial network attachment with the first base station. It is noted that this is the same procedure that a UE would perform to attach to a base station. But this is not done conventionally because the UE is already attached to its serving base station and thus would not attempt attachment to another base station.

Process 300 then proceeds to step 314, which includes receiving an uplink timing correction from the first base station. In an embodiment, after transmitting the signal in step 312, the UE remains tuned to the first base station frequency awaiting a Random Access Response (RAR) message sent by the first base station in response to the transmitted PRACH signal. The RAR message includes a power correction and the uplink timing correction. The uplink timing correction is typically a timing advancement.

After receiving the uplink timing correction, the UE does not continue the network attachment procedure with the first base station, to which the UE remains anonymous. Instead, process 300 proceeds to step 316, which includes determining a first propagation time estimate associated with the first base station based on the uplink timing correction. In an embodiment, the first propagation time estimate associated with the first base station is equal to one half of the uplink timing correction received from the first base station.

Next, step 318 includes generating an estimate of a propagation time difference between the first base station and the second base station. In an embodiment, step 318 includes subtracting the first propagation time estimate from a second propagation time estimate associated with the second base station to generate the estimate of the propagation time difference. In an embodiment, the second propagation time estimate associated with the second base station by performing steps 308, 310, 312, 314, and 316 with respect to the second base station. In another embodiment, where the second base station is the serving base station, the second propagation time estimate can be readily available to the UE because the UE is synchronized with its serving base station.

Process 300 then proceeds to step 320, which includes generating an estimate of a transmit time difference between the first base station and the second base station based on the estimate of the propagation time difference and an expected time difference of arrival between the first base station and the second base station. In an embodiment, the expected time difference of arrival between the first base station and the second base station is provided to the UE by the network. For example, the expected time difference of arrival can correspond to an expected RSTD between the first base station and the second base station received by the UE from a positioning server of the network. As described above, the expected RSTD accounts for the propagation time difference and the transmit time difference between the first base station and the second base station.

Finally, process 300 terminates in step 322, which includes computing a position of the UE based at least in part on the OTDOA determined in step 306 and the estimate of the transmit time difference generated in step 320. In an embodiment, steps 302 through 322 are performed with respect to a plurality of base stations such as the first base station, and the position of the UE is computed based on a set of measured OTDOAs and associated transmit time difference estimates from multiple base stations, coupled with knowledge of positions of the multiple base stations. In an embodiment, the position of the UE can be computed using a multi-lateration process as can be appreciated by a person of skill in the art based on the teachings herein.

It is noted that process 300 can be performed in parallel with regular data communication between the UE and its serving base station. For example, where the UE needs to transmit to the first base station (e.g., step 312), the UE may void scheduled uplink transmissions to the serving base station if they occur at the same time as the transmission to the first base station. Alternatively, the UE may select a random access resource element of the first base station that does not conflict with scheduled uplink transmissions to the serving base station.

In another embodiment, where the UE is equipped with at least two antenna elements, the UE can determine an Angle Difference of Arrival (ADOA) for multiple base stations relative to a reference base station, e.g., the serving base station of the UE. The ADOA associated with a base station represents a difference between angles of arrival (AOA) of signals received by the UE from the base station and the reference base station. In an embodiment, ADOA measurements for three base stations, coupled with knowledge of the positions of the three base stations, are sufficient to enable the UE to compute its position. It is noted that this embodiment is not dependent on timing differences (e.g., transmit time differences, propagation time differences) between base stations. As such, the UE can determine the AOA of different base stations at different times and no synchronization is required between the base stations.

In an embodiment, the UE relies on the following relationship between the complex power of a signal received by a two-element antenna array of the UE from a base station and the AOA of the signal incident on the antenna array to estimate the AOA of the signal:

$${r}_{AOA}^{( i )} = {y}_{0}^{( i )} ( k ) conj ( {y}_{1}^{( i )} ( k ) ) = \vert r \vert {e}^{j \frac{2 π d}{λ} cos ( {ϕ}_{AOA}^{( i )} + φ )} = \vert r \vert {e}^{j \frac{2 π d}{λ} cos {\hat{ϕ}}_{AOA}^{( i )}} \qquad ( 1 )$$

where r_{AOA}⁽ⁱ⁾, represents the complex power of the signal, yₒ⁽ⁱ⁾ and y₁⁽ⁱ⁾(k) represent first and second measurements obtained from processing the signal received by first and second antenna elements of the UE, |r| represents a real component of the power of the signal, d represents the distance between the first and second antenna elements, A represents the wavelength of the signal, φ_{AOA}⁽ⁱ⁾ represents the true AOA of the signal, φ represents an auxiliary phase offset due to phase mismatch between first and second receive chains of the UE which are coupled respectively to the first and second antenna elements, and \hat{φ}_{AOA}⁽ⁱ⁾ represents an estimate of the AOA of the signal. In an embodiment, yₒ⁽ⁱ⁾ and y₁⁽ⁱ⁾(k) represent the earliest arriving taps in the respective impulse responses (alternatively channel estimates in time domain) resulting from the signal being received by the first and second antenna elements of the UE.

Note that equation (1) allows for computing the estimate \hat{φ}_{AOA}⁽ⁱ⁾ of the AOA of the signal. The UE does not need to resolve the true AOA φ_{AOA}⁽ⁱ⁾, for a given base station. This is because the same auxiliary phase offset φ would be present in the estimate \hat{φ}_{AOA}⁽ⁱ⁾ for every base station and would thus be cancelled out when the ADOA between two base stations is calculated.

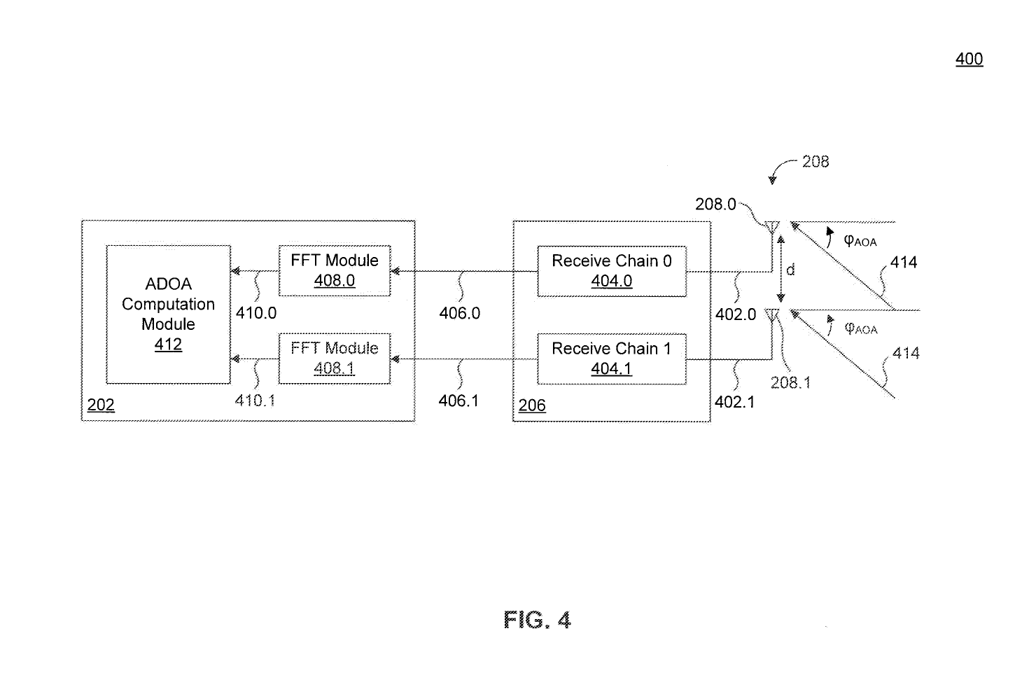

FIG. 4 illustrates an example UE 400 according to an embodiment which can be used to perform the above described ADOA-based approach for position computation. Example UE 400 is provided for the purpose of illustration only and is not limiting. As shown in FIG. 4, example UE 400 includes, without limitation, antenna array 208, including antenna elements 208.0 and 208.1; transceiver circuitry 206 including receive chains 404.0 and 404.1; and processor circuitry 202, including Fast Fourier Transform (FFT) modules 408.0 and 408.1 and ADOA computation module 412.

In an embodiment, antenna elements 208.0 and 208.1 receive a signal 414 from a base station. The base station can be any base station within range of UE 400. In an embodiment, the signal can be a PRS or a Cell-specific Reference Signal (CRS). Signal 414 is incident on antenna elements 208.0 and 208.1 with an angle of arrival φ_{AOA}⁽ⁱ⁾. Antenna elements 208.0 and 208.1 generate first and second radio frequency (RF) signals 402.0 and 402.1 respectively from the reception of signal 414.

Antenna elements 208.0 and 208.1 are coupled respectively to receive chains 404.0 and 404.1. Receive chains 404.0 and 404.1 act respectively on first and second RF signals 402.0 and 402.1 to generate first and second baseband signals 406.0 and 406.1. In an embodiment, receive chains 404.0 and 404.1 filter and down-convert first and second RF signals 402.0 and 402.1 to generate first and second baseband signals 406.0 and 406.1. Receive chains 404.0 and 404.1 may impart different phase changes on RF signals 402.0 and 402.1 such that an auxiliary phase offset p exists between receive chains 404.0 and 404.1.

Subsequently, first and second baseband signals 406.0 and 406.1 are converted from analog to digital and provided to processor circuitry 202. In processor circuitry 202, first and second baseband signals 406.0 and 406.1 are provided respectively to FFT modules 408.0 and 408.1, which transform first and second baseband signals 406.0 and 406.1 from a time domain representation to a frequency domain representation. FFT outputs 410.0 and 410.1 provide the contents of first and second baseband signals 406.0 and 406.1 grouped into a defined number of frequency bins. In an embodiment, the frequency bins correspond to frequency subcarriers contained in the received signal.

ADOA computation module 412 acts on FFT outputs 410.0 and 410.1 to generate first and second measurements respectively corresponding to the parameters yₒ⁽ⁱ⁾ and y₁⁽ⁱ⁾(k) in equation (1) above. In an embodiment, ADOA computation module 412 extracts from FFT outputs 410.0 and 410.1 respective signals corresponding to locations of a PRS or a CRS. The respective signals are de-scrambled with corresponding pilot sequences and the resulting signals are then transformed to the time domain, e.g., by applying them to respective Inverse FFTs (IFFTs). The yₒ⁽ⁱ⁾ and y₁⁽ⁱ⁾(k) in equation (1) above can then be obtained from the outputs of the respective IFFTs as corresponding to the dominant taps of the IFFTs. This corresponds to bin 0 in the special case where the receive FFT timing is aligned to the dominant tap location.

ADOA computation module 412 also computes a power associated with received signal 414 correspond to the parameter |r| in equation (1). Then, knowing the distance d between antenna elements 208.0 and 208.1 and the wavelength λ of signal 414, ADOA computation module 412 determines the value of \hat{φ}_{AOA}⁽ⁱ⁾ using equation (1).

As noted above, \hat{φ}_{AOA}⁽ⁱ⁾ represents a sum of the true AOA φ_{AOA}⁽ⁱ⁾ of signal 414 and the auxiliary phase offset φ between receive chains 404.0 and 404.1. Resolving the true AOA φ_{AOA}⁽ⁱ⁾ of signal 414 is not necessary however since UE position computation is based on differences between AOAs from multiple base stations and since φ is common and constant for all base stations.

In an embodiment, example UE 400 can repeat the above described process for multiple base stations generating an AOA estimate for each base station. UE 400 then generates ADOAs from the AOA estimates relative to a reference base station and uses the ADOAs together with the known positions of the multiple base stations to compute its own position.

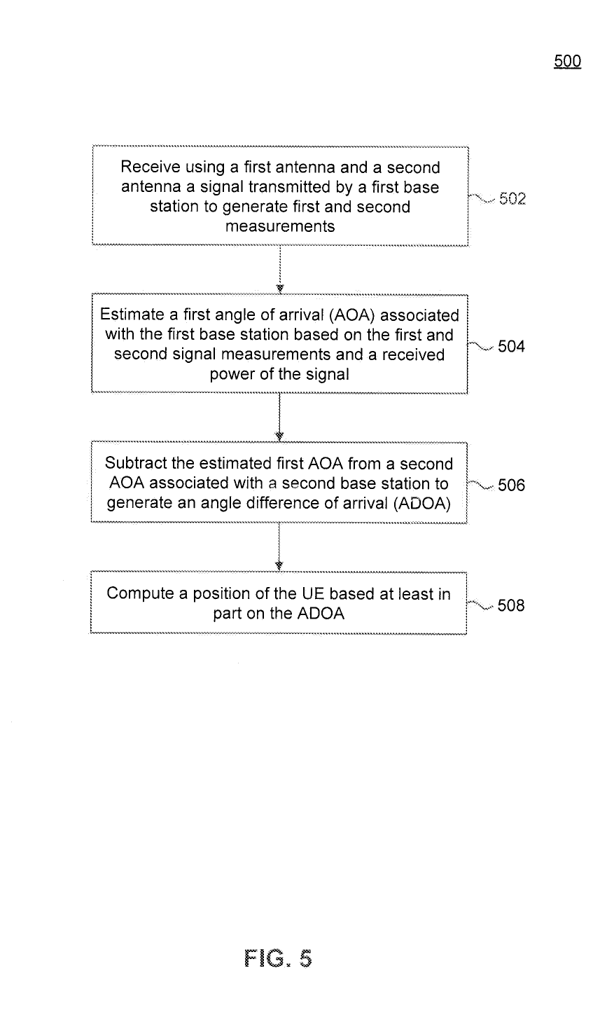

FIG. 5 is an example process 500 according to an embodiment. Example process 500 is provided for the purpose of illustration only and is not limiting. Example process 500 can be performed by a UE having at least two antenna elements, such as example UE 400, to compute its own position.

As shown in FIG. 5, example process 500 begins in step 502, which includes receiving using a first antenna and a second antenna a signal transmitted by a first base station to generate first and second measurements. In an embodiment, the signal is a PRS or a CRS. In an embodiment, step 502 further includes generating first and second signals from the receiving of the signal using the first antenna and the second antenna respectively; transforming the first and second signals from a time domain to a frequency domain; and sampling the transformed first and second signals to generate the first and second signal measurements.

Process 500 then proceeds to step 504, which includes estimating a first AOA associated with the first base station based on the first and second signal measurements and a received power of the signal. In an embodiment, step 504 includes estimating the first AOA using equation (1) above. Accordingly, step 504 includes generating a complex conjugate product of the first and second signal measurements, and estimating the first AOA based on the complex conjugate product and the received power of the signal.

Then, in step 506, process 500 includes subtracting the estimated first AOA from a second AOA associated with a second base station to generate an ADOA. In an embodiment, the second base station is a reference base station, which may be the serving base station of the UE.

Process 500 terminates in step 508, which includes computing a position of the UE based at least in part on the ADOA generated in step 506. In an embodiment, step 508 includes computing the position of the UE based on multiple ADOAs determined by repeating steps 502 to 506 for multiple base stations relative to the same reference base station, and using knowledge of the positions of the multiple base stations.

For purposes of this discussion, the term “module” shall be understood to include at least one of software, firmware, and hardware (such as one or more circuits, microchips, processors, or devices, or any combination thereof), and any combination thereof. In addition, it will be understood that each module can include one, or more than one, component within an actual device, and each component that forms a part of the described module can function either cooperatively or independently of any other component forming a part of the module. Conversely, multiple modules described herein can represent a single component within an actual device. Further, components within a module can be in a single device or distributed among multiple devices in a wired or wireless manner.

For the purposes of this discussion, the term “processor circuitry” shall be understood to include one or more: circuit(s), processor(s), or a combination thereof. For example, a circuit can include an analog circuit, a digital circuit, state machine logic, other structural electronic hardware, or a combination thereof. A processor can include a microprocessor, a digital signal processor (DSP), or other hardware processor. The processor can be “hard-coded” with instructions to perform corresponding function(s) according to embodiments described herein. Alternatively, the processor can access an internal or external memory to retrieve instructions stored in the memory, which when executed by the processor, perform the corresponding function(s) associated with the processor.

In this disclosure, terms defined by the Long-Term Evolution (LTE) standard are sometimes used. For example, the term “eNodeB” or “eNB” is used to refer to what is commonly described as a base station (BS) or a base transceiver station (BTS) in other standards. The term “User Equipment (UE)” is used to refer to what is commonly described as a mobile station (MS) or mobile terminal in other standards. However, as will be apparent to a person of skill in the art based on the teachings herein, embodiments are not limited to the LTE standard and can be applied to other wireless communication standards, including, without limitation, WiMAX, WCDMA, WLAN, and Bluetooth. As such, according to embodiments, an eNB in the disclosure herein can more generally be an Access Point (AP), where the AP encompasses APs (e.g., WLAN AP, Bluetooth AP, etc), base stations, or other network entities that terminate the air interface with the mobile terminal.

Embodiments have been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the disclosure that others can, by applying knowledge within the skill of the art, readily modify and/or adapt for various applications such specific embodiments, without undue experimentation, without departing from the general concept of the present disclosure. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of embodiments of the present disclosure should not be limited by any of the above-described exemplary embodiments as other embodiments will be apparent to a person of skill in the art based on the teachings herein.

What is claimed is:

1. A method performed by a User Equipment (UE), comprising:
determining an Observed Time Difference of Arrival (OTDOA) between a first base station and a second base station;
generating an estimate of a propagation time difference between the first base station and the second base station;
generating an estimate of a transmit time difference between the first base station and the second base station based on the estimate of the propagation time difference and an expected time difference of arrival between the first base station and the second base station; and
computing a position of the UE based at least in part on the OTDOA and the estimate of the transmit time difference.

2. The method of claim 1, wherein determining the OTDOA between the first base station and the second base station comprises:
receiving a reference signal from the first base station;
determining a time of arrival (TOA) associated with the first base station based on a receive time of the reference signal; and
subtracting the TOA associated with the first base station from a TOA associated with the second base station to determine the OTDOA.

3. The method of claim 2, wherein the reference signal includes a Positioning Reference Signal (PRS).

4. The method of claim 2, wherein the TOA associated with the first base station corresponds to a receive start time of a downlink subframe transmitted by the first base station.

5. The method of claim 1, wherein the OTDOA between the first base station and the second base station corresponds to a sum of the propagation time difference and the transmit time difference between the first base station and the second base station.

6. The method of claim 1, wherein the transmit time difference between the first base station and the second base station corresponds to a difference between transmission start times of a first downlink subframe transmitted by the first base station and a second downlink subframe transmitted by the second base station.

7. The method of claim 1, wherein generating the estimate of the propagation time difference between the first base station and the second base station comprises:
transmitting a signal to the first base station configured to coincide with a random access resource element associated with the first base station; and
receiving an uplink timing correction from the first base station.

8. The method of claim 7, wherein generating the estimate of the propagation time difference between the first base station and the second base station further comprises:
determining a first propagation time estimate associated with the first base station based on the uplink timing correction; and
subtracting the first propagation time estimate from a second propagation time estimate associated with the second base station to generate the estimate of the propagation time difference.

9. The method of claim 8, wherein the first propagation time estimate associated with the first base station is equal to one half of the uplink timing correction.

10. The method of claim 7, wherein the random access resource element is a Physical Random Access Channel (PRACH) resource element.

11. The method of claim 10, further comprising:
decoding a System Information Block (SIB) message associated with the first base station; and
determining a frequency subcarrier and a time slot associated with the PRACH resource element from the SIB message.

12. The method of claim 7, wherein the transmitting the signal to the first base station comprises:
receiving a reference signal from the first base station;
determining a time of arrival (TOA) associated with the first base station based on a receive time of the reference signal, wherein the TOA corresponds to a receive start time of a downlink subframe transmitted by the first base station; and
transmitting the signal to the first base station based on the determined TOA.

13. The method of claim 1, wherein the expected time difference of arrival between the first base station and the second base station accounts for the propagation time difference and the transmit time difference.

14. The method of claim 1, wherein the expected time difference of arrival between the first base station and the second base station corresponds to an expected Received Signal Time Difference (RSTD) between the first base station and the second base station received from a positioning server.

15. The method of claim 1, wherein the first base station corresponds to a non-serving base station of the UE and the second base station corresponds to a serving base station of the UE.

16. A method performed by a User Equipment (UE) having first and second antenna elements, comprising:
receiving using the first and second antenna elements a signal transmitted by a first base station to generate first and second signal measurements;
estimating a first angle of arrival (AOA) associated with the first base station based on the first and second signal measurements and a received power of the signal; and
subtracting the estimated first AOA from a second AOA associated with a second base station to generate an angle difference of arrival (ADOA); and
computing a position of the UE based at least in part on the ADOA.

17. The method of claim 16, wherein the signal is a Positioning Reference Signal (PRS) or a Cell-specific Reference Signal (CSR).

18. The method of claim 16, further comprising:
generating first and second signals from the receiving of the signal using the first antenna and the second antenna respectively;
transforming the first and second signals from a time domain to a frequency domain; and
sampling the transformed first and second signals to generate the first and second signal measurements.

19. The method of claim 16, further comprising:
generating a complex conjugate product of the first and second signal measurements; and
estimating the first AOA based on the complex conjugate product and the received power of the signal.

20. A method performed by a User Equipment (UE), comprising:
receiving an expected time difference of arrival between a first base station and a second base station;
determining an Observed Time Difference of Arrival (OTDOA) between the first base station and the second base station;
generating an estimate of a transmit time difference between the first base station and the second base station based on the expected time difference of arrival and an estimate of a propagation time difference between the first base station and the second base station; and
computing a position of the UE based at least in part on the OTDOA and the estimate of the transmit time difference.
